(19) United States
(12) Patent Application Publication
(10) Pub. No.: US 2025/0377261 A1
(43) Pub. Date: Dec. 11, 2025

(54) INERTIAL ACTUATION DEVICE FOR MODAL TESTING OF STRUCTURES

(71) Applicant: The Boeing Company, Arlington, VA (US)

(72) Inventor: Steven F. Griffin, Kihei, HI (US)

(21) Appl. No.: 18/740,182

(22) Filed: Jun. 11, 2024

(51) Int. Cl. G01M 7/02

(52) U.S. Cl. CPC G01M 7/027; G01M 7/025

(57) ABSTRACT

A method of modal testing a structure may include rigidly coupling a body of an inertial shaker to a structure under test, wherein the shaker has a rodless inertial mass enclosed in a housing and a voice coil configured to move the inertial mass in alternating directions within the housing. The shaker is activated by applying an alternating current to the voice coil at a selected frequency, and the resulting vibration response is measured at various points on the structure under test.

### FIELD

This disclosure relates to systems and methods for modal testing. More specifically, the disclosed embodiments relate to shaker devices and systems for such testing.

### BACKGROUND

Modal testing or experimental modal analysis is a technique used in the aircraft manufacturing industry to characterize the dynamic behavior of aircraft structures. This form of testing involves exciting a structure with a known force input and measuring the resulting vibration responses at various points. The force input can be generated by devices such as shakers, hammers, and acoustic generators. Vibration responses can be measured by sensors such as accelerometers, strain gauges, and microphones.

In this manner, the testing can identify the natural frequencies, mode shapes, and damping ratios of the structure, also referred to as its modal parameters. Modal testing can be used for such purposes as validating analytical models, conducting flutter analysis, and ground vibration testing (GVT). Results can facilitate the verification of design specifications, detection of structural defects, and optimization of structural modifications. Modal testing can be expensive and time-consuming, especially for large and complex structures.

### SUMMARY

The present disclosure provides improved systems, apparatuses, and methods relating to modal testing.

In some examples, a method of modal testing a structure may include: rigidly coupling a body of an inertial shaker to a structure under test, wherein the inertial shaker comprises an inertial mass enclosed in a housing and a voice coil configured to move the inertial mass in alternating directions within the housing; activating the shaker by applying an alternating current to the voice coil at a selected frequency; and measuring a resulting vibration response at one or more points on the structure under test.

In some examples, method of modal testing a structure may include: rigidly coupling a housing of an inertial shaker assembly to a structure under test, wherein the inertial shaker assembly comprises an inertial mass reciprocating inertial mass enclosed in the housing and one or more force transducers affixed between the housing and the structure under test.

In some examples, a modal testing system may include: a shaker comprising an inertial mass enclosed in an outer housing, and a voice coil configured to generate a magnetic field to move the inertial mass in reciprocating directions within the outer housing; a mounting surface rigidly coupled to the outer housing; and one or more force transducers disposed between the housing and the mounting surface.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic elevation view of an aircraft undergoing traditional modal testing.

FIG. 2 is a schematic elevation view of the aircraft of FIG. 1 undergoing modal testing using an illustrative modal testing system of the present teachings.

FIG. 3 is a schematic diagram of elements of the modal testing systems of the present disclosure for purposes of mathematical illustration.

FIG. 4 is a schematic diagram of an illustrative embodiment of a modal testing system in accordance with aspects of the present disclosure.

FIG. 5 is a flow chart depicting steps of an illustrative method for modal testing a structure according to the present teachings.

### DETAILED DESCRIPTION

Various aspects and examples of a modal testing system, as well as related methods, are described below and illustrated in the associated drawings. Unless otherwise specified, a modal testing system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Rigid” describes a material or structure or assembly configured to be stiff, non-deformable, or substantially lacking in flexibility under normal operating conditions.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

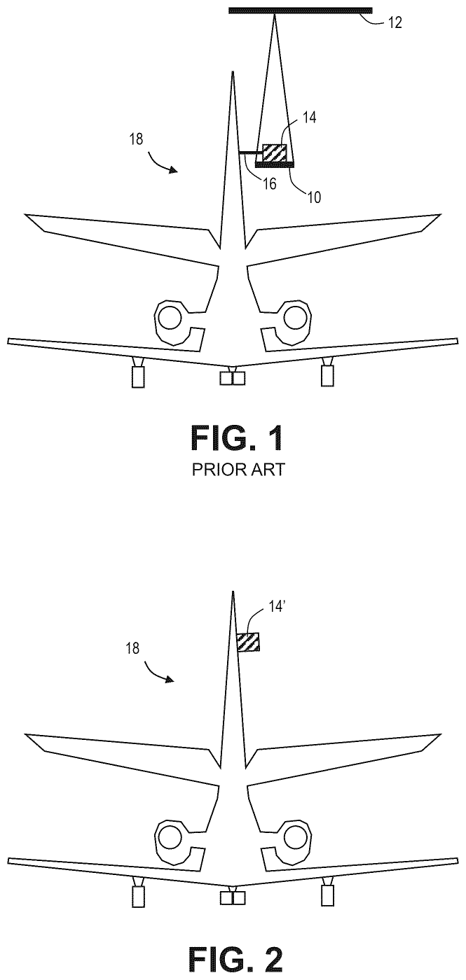

Known shakers for modal testing include a piston-like reciprocating rod or shaft. The shaft is coupled to the load under test by a “stinger” or sacrificial rod, and a force transducer is disposed between the stinger and the load. When performing modal testing on aircraft or other structures, especially in a horizontal direction, it is often challenging to construct a boundary condition for shakers to react against. Building a ground-based support structure to hold the shaker is often impractical. As depicted in FIG. 1, a common approach is therefore to hang a platform 10 from a crane 12 or other support and to mount the shaker 14 on that platform. A reciprocating rod/stinger combination 16 connects the shaker to the structure or load 18 under test. As in the situation shown in FIG. 1, the testing of large structures such as aircraft (e.g., vertical tail testing) often must be conducted quite high above the ground or floor where worker access may be limited or precarious. Accordingly, safety issues must be addressed during setup, testing, and teardown phases both at the test rig and on the ground below. This approach requires additional hardware and complexity, and increases the safety measures that must be taken when workers are in the area. This approach also often results in insufficient force being applied to the load under test, as well as undesired (e.g., nonlinear) motion of the shaker and its platform.

In general, modal testing systems in accordance with the present teachings may include a rodless inertial shaker with integrated force transduction. The inertial shaker may include a voice coil actuator (e.g., having a moving coil). The coil may be wound around a non-magnetic bobbin that moves in and out of a permanent magnetic field assembly including a concentric permanent magnet. As the reciprocating mass of the inertial shaker is self-contained (e.g., without any moving parts penetrating the housing), the shaker may be coupled more directly to the load, e.g., via the shaker's body or housing (or a part thereof, e.g., a base), and the use of rods and stingers is eliminated while retaining the functionality of the modal testing system. In some examples, commercially available haptic shaker devices used in home entertainment (e.g., to shake chairs or other furniture when a user is gaming or listening to music) may be suitable for use in systems of the present disclosure. In some examples, inertial shakers of the present disclosure comprise a haptic actuator configured to utilize a mass suspended on flexures and driven by a relatively large voice coil to impart inertial force at the point of attachment.

Modal testing involves measuring the magnitude of the force being applied to the surface of the structure under test. Accordingly, shaker systems of the present disclosure may further include one or more force transducers disposed at the point of attachment (e.g., at a mounting surface). As explained herein, the force transducer(s) are rigidly coupled between the body of the shaker and the mounting plate or other surface (if present) for connection to the load under test. This is in contrast to standard modal testing systems, where the force transducer is disposed at the end of the stinger, which is itself attached to a shaft that moves relative to the stationary body of the shaker. For example, one or more piezoceramic force transducers (e.g., wafers) may be utilized. Other suitable transducers may include strain gauge load cells, capacitive force sensors, inductive force sensors, resonant force sensors, quartz crystal force sensors, and/or the like. Piezoceramic wafers may be advantageous due to their dynamic response, high sensitivity, and ability to measure small forces with precision.

Two methods may be utilized separately or in tandem for measuring the force input of the inertial shaker. One is to use the (e.g., piezoelectric) sensors embedded in the mounting plate of the shaker or otherwise rigidly fastened to the shaker assembly. The other is to monitor the current going into the voice coil of the shaker, which is proportional to the force constant and the differential force between the suspended mass and the structure.

Use of a mathematical model and the force transducer allows decoupling of the added dynamics introduced by attaching the inertial shaker to the article under test. For example, the suspended shaker of FIG. 1 may be replaced with a small instrumented inertial shaker 14′ as shown in FIG. 2. This results in an improved test system that can be used to derive the uncoupled dynamics of the device under test. The example of FIG. 2 and other examples using a direct-connect inertial shaker take advantage of piezoceramic wafers at the attachment point, which serve as force transducers, as well as the mathematics used to decouple the effect of attaching the shaker. Among other benefits, examples of the improved testing system described herein allow excitation of the structure in a modal test without complicated suspension by crane or other apparatus, include a built-in force transducer decoupling the attached inertial shaker dynamics from the structure under test, and reduce safety issues, stinger breakage, and nonlinear dynamics. Moreover, test systems of the present disclosure may facilitate greater flexibility in the location and number of shakers that can be placed on the same structure, e.g., with different orientations or force vectors.

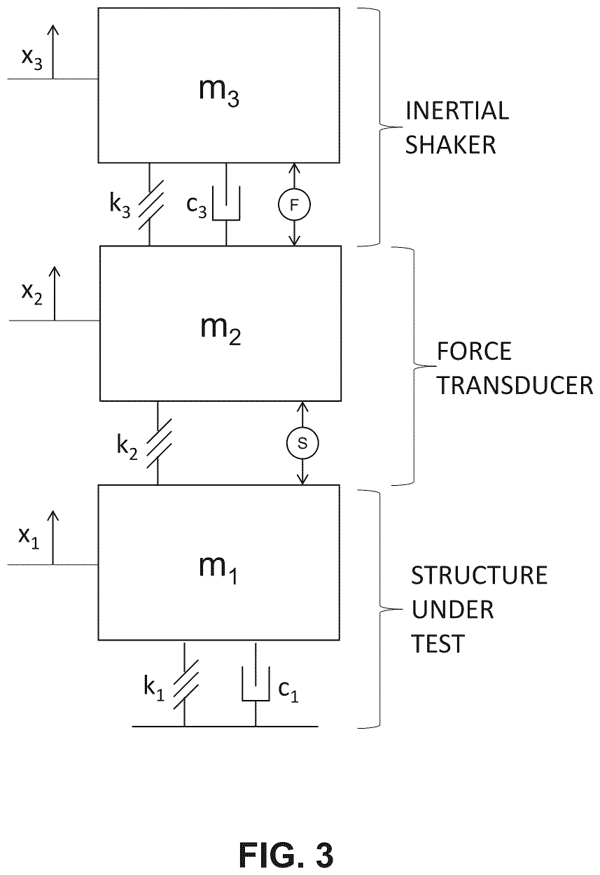

To further understand the math involved in the assembled inertial shaker device, a model was developed of the system shown in FIG. 3. The top spring/mass/damper in FIG. 3 represents the inertial shaker; the middle portion represents the piezoceramic interface between the inertial shaker and the structure under test at the bottom of the diagram.

The system of FIG. 3 results in five coupled differential equations:

$$\begin{matrix}{m}_{3} {\ddot{x}}_{3} + {c}_{3} ( {\dot{x}}_{3} - {\dot{x}}_{2} ) + {k}_{3} ( {x}_{3} - {x}_{2} ) = F \\ {m}_{2} {\ddot{x}}_{2} + {c}_{3} ( {\dot{x}}_{2} - {\dot{x}}_{3} ) + {k}_{3} ( {x}_{2} - {x}_{3} ) + {k}_{2} ( {x}_{2} - {x}_{1} ) = - F \\ {m}_{1} {\ddot{x}}_{1} + {c}_{1} {\dot{x}}_{1} + {k}_{1} {x}_{1} + {k}_{2} ( {x}_{1} - {x}_{2} ) = 0 \\ s = ( {x}_{2} - {x}_{1} ) \\ {F}_{sensed} = {k}_{2} s\end{matrix}$$

If these equations are solved simultaneously, a prediction of the displacement of mass m₁, can be obtained due to an application of the differential force F that would be applied by a voice coil that applies a differential force to m₁ and m₂ when a voltage is applied to the coil. This displacement is often depicted in the frequency domain as a frequency response function with displacement in the numerator and force in the denominator. In this way, the response of the mass to a given force as a function of frequency can be plotted. If the force in the denominator is the differential applied force, the dynamics of both m₂ and m₃ influence the response and must be considered. If the force is the force sensed F_{sensed} then the coupled equations reduce to:

$${m}_{1} {\ddot{x}}_{1} + {c}_{1} {\dot{x}}_{1} + {k}_{1} {x}_{1} = {F}_{sensed}$$

and the response of the mass is not influenced by the presence of m₂ and m₃. This means that the structure under test can be tested without observing the additional dynamics of m₂ and m₃ (which represent the inertial shaker).

The preceding development is also true of a suspended shaker with a force transducer in series. The difference in practice is that the suspended shaker is nonlinear and the linear equations do not always adequately predict the behavior.

Moreover, including the equation for the differential force applied by the voice coil:

$$F = {B}_{l} i$$

(where i is current and B is flux density) can allow a complete model of the additional dynamics of the added voice coil. With this understood, one may monitor the applied current to the voice coil and additional dynamics introduced by the inertial shaker can be mathematically divided out of the response of the structure. Furthermore, if the frequency of the inertial shaker is set well below the measured dynamics of interest, the differential force F (which can be determined by monitoring the applied current) converges on the same answer as that of a force transducer. This is because the frequency separation greatly reduces coupling. Accordingly, in some embodiments force transducers may be unnecessary and/or function as a redundant source of information. In some examples, a simple measurement of the uncoupled behavior of the inertial actuator could be used to derive the uncoupled behavior of the device under test using only the applied current. The math modeling the results of adding an inertial actuator is well understood and can be used to recover the uncoupled frequency response function of the host structure. In addition, at frequencies well above the uncoupled resonant frequency of the inertial shaker, it can be shown that the differential force into the shaker is equal to the force applied to the structure.

Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

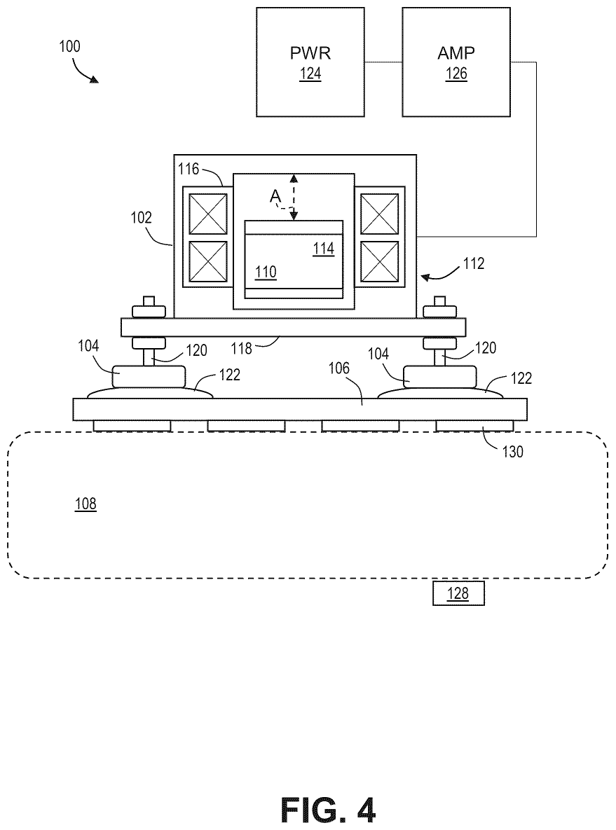

Turning now to FIG. 4, an illustrative non-exclusive example of a modal testing system 100 is illustrated schematically. The example of FIG. 4 is illustrative and does not limit modal testing systems of the present disclosure to the features shown.

System 100 includes an inertial shaker 102 coupled to a pair of force transducers 104, and a mounting plate 106, such that the combination of shaker 102, transducers 104, and mounting plate 106 form a rigid shaker assembly configured to be mounted directly to a structure 108 under test.

Inertial shaker 102 may include any suitable inertial or haptic shaking device having an inertial mass 110 enclosed in a housing 112, with a voice coil 114 and permanent magnet assembly 116 configured to move inertial mass 110 in reciprocating directions within housing 112. In some examples, relative positions of the voice coil and the magnets may be as schematically depicted in FIG. 4, or may be otherwise configured, e.g., such that the voice coil is stationary. Suitable examples of inertial shaker 102 are currently available on the commercial market, such as the Buttkicker® line of haptic transducers. However, any suitable self-contained haptic shaker may be utilized in system 100. In some examples, the inertial mass may be referred to as a reciprocating piston.

Housing 112 may be referred to as the body of the shaker, and may include any suitable structural enclosure configured to accommodate inertial mass 110, magnet assembly 116, and voice coil 114. Housing 112 may comprise a nonconductive material, such as plastic. Housing 112 may further include a base 118 and/or a bracket or other mechanism for attaching housing 112 to a host structure. In system 100, base 118 is coupled mechanically and electrically to force transducers 104 in a rigid manner, using respective conductive fasteners 120 (e.g., copper bolts). Force transducers 104 may include any suitable sensors configured to convert a sensed force into an electrical signal. In this example, transducers 104 are piezoceramic wafers.

Transducers 104 may be affixed to mounting plate 106 in any suitable manner. This connection may also be electrically conductive. In this example, transducers 104 are fastened to the mounting plate using a conductive adhesive 122 or epoxy, although other fasteners may be utilized. Mounting plate 106 may include any suitable structure or combination of structures configured to provide a stable and/or rigid mounting surface to connect system 100 to structure 108. For example, mounting plate 106 may comprise an expanse of material, such as aluminum or steel. In some examples, a plurality of mounting plates are used, e.g., with one mounting plate under each force transducer.

Inertial mass 110 is configured to reciprocate along an axis A. In some examples, mounting plate 106 lies in the path of axis A between the shaker and the load under test. In other words, axis A may intersect the mounting surface. This configuration is not possible with standard modal shakers, as it would interfere with the reciprocating shaft and prevent the shaker from being coupled to the load.

Fasteners 120 and mounting plate 106 are described above as comprising conductive materials such as copper and aluminum, which facilitates the connection of measuring devices to force transducers 104 (e.g., leads may be attached to the fasteners and the mounting plate). However, other configurations are possible, such as using non-conductive fasteners 120 and/or mounting plate 106 with force transducers that have integrated leads or attachment points for leads or sensor wires.

Mounting plate 106 is described above as being rigidly coupled to the shaker by way of base 118 via the force transducer hardware. However, mounting plate 106 may be rigidly coupled (directly or indirectly) to the base of the shaker, the housing of the shaker, a bracket of the shaker, and/or any other suitable outer portion of the shaker such that the mounting plate and the shaker body collectively form a substantially rigid assembly. In other words, although the inertial mass moves within the shaker body/housing, the shaker body and the mounting plate are configured to prevent movement relative to each other.

System 100 may further include a power supply 124 to power inertial shaker 102 and an amplifier 126 configured to amplify the power signal to drive the voice coil at a selected frequency. Inertial shaker 102 may be configured to operate at relatively low frequencies, such as 10 Hz to 100 Hz.

Accordingly, modal testing system 100 is configured to excite structure 108 when mounted rigidly to the structure and powered by power supply 124. One or more systems 100 may be coupled to structure 108 in any suitable manner, including, for example using an adhesive, adhesive tape 130, wax, and/or any other suitable device configured to removably attach the system to the load. The effects of this excitation may be measured using any suitable device or apparatus, illustrated in FIG. 4 representatively by an accelerometer 128.

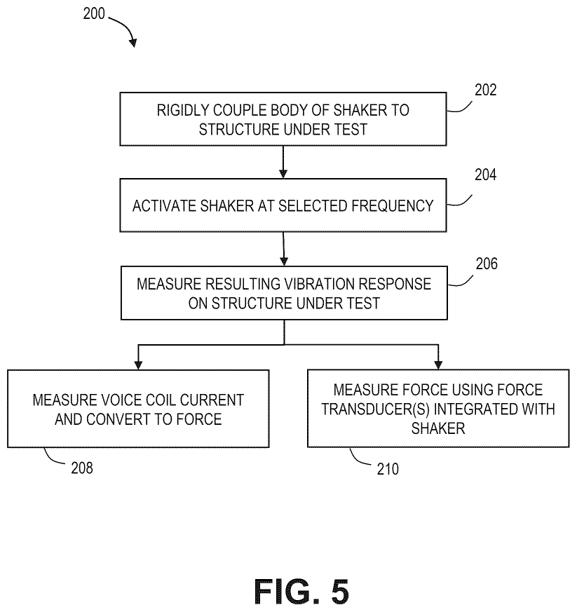

FIG. 5 schematically provides a flowchart that represents an illustrative, non-exclusive example of a method according to the present disclosure. In this flowchart, some steps may be illustrated in dashed boxes indicating that such steps may be optional or may correspond to an optional version of a method according to the present disclosure. That said, not all methods according to the present disclosure are required to include the steps illustrated in solid boxes. The method and steps illustrated in FIGS. 5 are not limiting and other methods and steps are within the scope of the present disclosure, including methods having greater than or fewer than the number of steps illustrated, as understood from the discussions herein.

With reference to FIG. 5, step 202 of a method 200 of modal testing a structure includes rigidly coupling the body or housing of an inertial shaker to a structure under test (e.g., using an adhesive, adhesive tape, and/or wax), wherein the shaker comprises an inertial mass enclosed in the housing and a voice coil configured to move the inertial mass in alternating directions within the housing. Said another way, step 202 may include rigidly coupling a housing of an inertial (e.g., haptic) shaker to a structure under test (e.g., using an adhesive, adhesive tape, and/or wax), wherein the inertial shaker comprises a reciprocating (e.g., rodless) piston enclosed in the housing and one or more force transducers affixed between the housing and the structure under test. In some examples, the reciprocating piston is configured to move in alternating directions relative to the housing. In some examples, the inertial shaker further comprises a voice coil actuator configured to move the reciprocating piston.

In some examples, rigidly coupling the inertial shaker to the structure under test includes securing one or more mounting plates of the shaker to the structure under test. In some examples, the one or more mounting plates are rigidly coupled to one or more force transducers. In some examples, the inertial mass is configured to move along an axis, and securing the one or more mounting plates to the structure under test further comprises placing at least one of the mounting plates in the path of the axis between the housing and the structure under test. Said another way, for example, the reciprocating piston may be configured to move along a piston axis, and securing the one or more mounting plates to the structure under test may further comprise placing at least one of the mounting plates in the path of the piston axis between the housing and the structure under test. For example, at least one of the mounting plates may be oriented orthogonal to the axis.

Step 204 of method 200 includes activating the shaker by applying an alternating current to the voice coil at a selected frequency (e.g., 10 Hz to 100 Hz). In other words, this step includes exciting the structure under test by activating the inertial shaker. For example, this step may include activating the inertial shaker at a frequency of 10 Hz to 100 Hz.

Step 206 of method 200 includes measuring a resulting vibration response at one or more points on the structure under test. For example, this step may be conducted using one or more accelerometers.

One or both of steps 208 and 210 may be performed:

Step 208 of method 200 includes measuring the alternating current (i.e., the voice coil input current) and converting the measured input current into a force applied to the structure under test.

Step 210 of method 200 includes measuring a force applied to the structure under test using one or more force transducers rigidly coupled both to the housing and to the structure under test. For example, the force transducers may include a piezoelectric transducer (e.g., a piezoceramic material, e.g., a wafer).

Illustrative, non-exclusive examples of inventive subject matter according to the present disclosure are described in the following enumerated paragraphs:

A0. A method of modal testing a structure, the method comprising:
rigidly coupling a housing or body of an inertial shaker assembly to a structure under test, wherein the inertial shaker assembly comprises a reciprocating piston enclosed in the housing and one or more force transducers affixed between the housing and the structure under test.

A1. The method of A0, further comprising exciting the structure under test by activating the inertial shaker.

A2. The method of A0 or A1, wherein the reciprocating piston is configured to move in alternating directions relative to the housing.

A3. The method of any one of A0 through A2, wherein the inertial shaker further comprises a voice coil actuator configured to move the reciprocating piston

A4. The method of any one of paragraphs A1 through A3, further comprising measuring a resulting vibration response at one or more points on the structure under test.

A5. The method of A4, wherein measuring the resulting vibration response is conducted using one or more accelerometers.

A6. The method of any one of paragraphs A0 through A5, further comprising coupling the inertial shaker to the structure under test using a temporary fastener.

A7. The method of A6, wherein the temporary fastener comprises an adhesive (e.g., an adhesive tape).

A8. The method of A6, wherein the temporary fastener comprises a wax.

A9. The method of any one of paragraphs A0 through A8, wherein rigidly coupling the inertial shaker to the structure under test includes securing one or more mounting plates of the shaker assembly to the structure under test, wherein the one or more mounting plates are rigidly coupled to the one or more force transducers.

A10. The method of A9, wherein the reciprocating piston is configured to move along a piston axis, and securing the one or more mounting plates to the structure under test further comprises placing at least one of the mounting plates in the path of the piston axis between the housing and the structure under test.

A11. The method of A10, wherein at least one of the mounting plates is oriented orthogonal to the piston axis.

A12. The method of any one of paragraphs A0 through A11, wherein the piston

A13. The method of any one of paragraphs A0 through A12, wherein the inertial shaker comprises a haptic shaker.

A14. The method of any one of paragraphs A0 through A13, further comprising activating the inertial shaker at a frequency of 10 Hz to 100 Hz.

A15. The method of any one of paragraphs A0 through A14, further comprising measuring an input current used to activate the inertial shaker.

A16. The method of any one of paragraphs A0 through A14, further comprising converting the measured input current into a force applied to the structure under test.

A17. The method of any one of paragraphs A0 through A14, further comprising measuring a force applied to the structure under test using the one or more force transducers.

A18. The method of any one of paragraphs A0 through A17, wherein the one or more force transducers comprise a piezoelectric transducer.

A19. The method of A18, wherein the piezoelectric transducer comprises a piezoceramic material.

A20. The method of any one of paragraphs A0 through A19, wherein the structure under test comprises an aircraft skin.

B0. A modal testing system, comprising:
a shaker comprising an inertial mass enclosed in an outer housing, and a voice coil configured to generate a magnetic field to move the inertial mass in reciprocating directions within the outer housing;
a mounting surface rigidly coupled to the outer housing; and
one or more force transducers disposed between the housing and the mounting surface.

B1. The modal testing system of B0, further comprising an amplifier configured to amplify a power signal to drive the voice coil at a selected frequency.

B2. The modal testing system of B1, wherein the frequency is 10 Hz to 100 Hz.

B3. The modal testing system of any one of B0 through B2, wherein the one or more force transducers are piezoelectric.

B4. The modal testing system of B3, wherein the one or more force transducers comprise a piezoceramic material.

B5. The modal testing system of any one of B0 through B4, wherein the inertial mass is configured to reciprocate along an axis, and the axis intersects the mounting surface.

B6. The modal testing system of any one of B0 through B5, wherein the shaker is rodless.

B7. The modal testing system of any one of B0 through B6, wherein the shaker is configured to excite a structure under test when mounted to the structure using the mounting surface.

B8. The modal testing system of any one of B0 through B7, wherein the inertial mass is configured to move in alternating directions relative to the housing.

B9. The modal testing system of any one of B0 through B8, wherein the one or more force transducers are rigidly coupled to both the mounting surface and the shaker housing.

B10. The modal testing system of any one of B0 through B9, wherein the mounting surface comprises a plate oriented orthogonal to an axis of reciprocation of the inertial mass.

C0. A method of modal testing a structure, the method comprising:
rigidly coupling a body of a shaker to a structure under test, wherein the shaker comprises an inertial mass enclosed in a housing and a voice coil configured to move the inertial mass in alternating directions within the housing;
activating the shaker by applying an alternating current to the voice coil at a selected frequency; and
measuring a resulting vibration response at one or more points on the structure under test.

C1. The method of C0, wherein measuring the vibration response comprises using one or more accelerometers.

C2. The method of C0 or C1, wherein the selected frequency is 10 Hz to 100 Hz.

C3. The method of any one of C0 through C2, further comprising coupling the shaker to the structure under test using a temporary fastener.

C4. The method of C3, wherein the temporary fastener comprises an adhesive (e.g., an adhesive tape).

C5. The method of C3, wherein the temporary fastener comprises a wax.

C6. The method of any one of paragraphs C0 through C5, wherein rigidly coupling the inertial shaker to the structure under test includes securing one or more mounting plates to the structure under test.

C7. The method of C6, wherein one or more force transducers are disposed between the one or more mounting plates and the body of the shaker.

C8. The method of C6 or C7, wherein the inertial mass is configured to move along an axis, and securing the one or more mounting plates to the structure under test further comprises placing at least one of the mounting plates in the path of the axis between the housing and the structure under test.

C9. The method of C8, wherein at least one of the mounting plates is oriented orthogonal to the axis.

C10. The method of any one of paragraphs C0 through C9, further comprising measuring the alternating current and converting the measured input current into a force applied to the structure under test.

C11. The method of any one of paragraphs C0 through C10, further comprising measuring a force applied to the structure under test using one or more force transducers rigidly coupled both to the housing and to the structure under test.

C12. The method of C11, wherein the one or more force transducers comprise a piezoelectric transducer.

C13. The method of C12, wherein the piezoelectric transducer comprises a piezoceramic wafer.

C14. The method of any one of paragraphs C0 through C13, wherein the structure under test comprises an aircraft skin.

The different embodiments and examples of the modal testing systems and methods described herein provide several advantages over known solutions. For example, illustrative embodiments and examples described herein allow excitation of structure in a modal test without complicated suspension by crane or other apparatus.

Additionally, and among other benefits, illustrative embodiments and examples described herein include a built-in force transducer, decoupling the attached inertial shaker dynamics from the structure under test.

Additionally, and among other benefits, illustrative embodiments and examples described herein allow the use of mathematical methods to measure uncoupled dynamics of the structure under test using applied differential force as measured by applied current to the inertial shaker.

Additionally, and among other benefits, illustrative embodiments and examples described herein have an inertial shaker with a low enough uncoupled resonant frequency such that the inertial force applied to the attached shaker is equal to the force applied to the structure.

Additionally, and among other benefits, illustrative embodiments and examples described herein reduce safety issues, stinger breakage, nonlinear dynamics, and (in some cases) the need for a separate force sensor.

Additionally, and among other benefits, illustrative embodiments and examples described herein allow for greater flexibility in placing multiple shakers on a same structure, e.g., with different orientations or force vectors.

No known system or device can perform these functions. However, not all embodiments and examples described herein provide the same advantages or the same degree of advantage.

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method of modal testing a structure, the method comprising:
rigidly coupling a body of an inertial shaker to a structure under test, wherein the inertial shaker comprises an inertial mass enclosed in a housing and a voice coil configured to move the inertial mass in alternating directions within the housing;
activating the inertial shaker by applying an alternating current to the voice coil at a selected frequency; and
measuring a resulting vibration response at one or more points on the structure under test.

2. The method of claim 1, wherein measuring the resulting vibration response comprises using one or more accelerometers.

3. The method of claim 1, further comprising coupling the inertial shaker to the structure under test using a temporary fastener.

4. The method of claim 1, wherein rigidly coupling the inertial shaker to the structure under test includes securing one or more mounting structures of the inertial shaker to the structure under test.

5. The method of claim 4, wherein one or more force transducers are disposed between the one or more mounting structures and the body of the inertial shaker.

6. The method of claim 4, wherein the one or more mounting structures comprise a mounting plate and the inertial mass is configured to move along an axis, wherein securing the mounting plate to the structure under test further comprises placing the mounting plate in a path of the axis, between the housing and the structure under test.

7. The method of claim 6, wherein the mounting plate is oriented orthogonal to the axis.

8. The method of claim 1, further comprising measuring the alternating current and converting the measured input current into a force applied to the structure under test.

9. The method of claim 1, further comprising measuring a force applied to the structure under test using one or more force transducers rigidly coupled both to the housing and to the structure under test.

10. A method of modal testing a structure, the method comprising:
rigidly coupling a housing of an inertial shaker assembly to a structure under test, wherein the inertial shaker assembly comprises an inertial shaker having a reciprocating inertial mass enclosed in the housing and one or more force transducers affixed between the housing and the structure under test.

11. The method of claim 10, further comprising exciting the structure under test by activating the inertial shaker.

12. The method of claim 11, further comprising measuring a resulting vibration response at one or more points on the structure under test.

13. The method of claim 10, wherein the inertial shaker further comprises a voice coil actuator configured to move the reciprocating inertial mass.

14. The method of claim 10, wherein rigidly coupling the housing of the inertial shaker assembly to the structure under test includes securing one or more mounting plates of the shaker assembly to the structure under test, wherein the one or more mounting plates are rigidly coupled to the one or more force transducers.

15. The method of claim 14, wherein the reciprocating inertial mass is configured to move along an axis, and securing the one or more mounting plates to the structure under test further comprises placing at least one of the mounting plates in a path of the axis between the housing and the structure under test.

16. A modal testing system, comprising:
a shaker comprising an inertial mass enclosed in an outer housing, and a voice coil configured to generate a magnetic field to move the inertial mass in reciprocating directions within the outer housing;
a mounting surface rigidly coupled to the outer housing; and
one or more force transducers disposed between the housing and the mounting surface.

17. The modal testing system of claim 16, further comprising an amplifier configured to amplify a power signal to drive the voice coil at a selected frequency.

18. The modal testing system of claim 16, wherein the one or more force transducers are piezoelectric.

19. The modal testing system of claim 16, wherein the inertial mass is configured to reciprocate along an axis, and the axis intersects the mounting surface.

20. The modal testing system of claim 16, wherein the shaker is configured to excite a structure under test when mounted to the structure using the mounting surface.
